(19) United States
(12) Patent Application Publication
(10) Pub. No.: US 2009/0307001 A1
(43) Pub. Date: Dec. 10, 2009

(54) CRM CLIENT ARCHITECTURE CONDUCIVE TO INTERACTION WITH OTHER APPLICATIONS EXECUTING IN THE SAME CLIENT SYSTEM

(75) Inventors: Bikram Singh Gill, Mohali (Chandigarh) (IN); Amar Kangod Ganapathi, Bangalore (IN); Harish Gowda, Bangalore (IN)

Correspondence Address: LAW FIRM OF NAREN THAPPETA, C/o Landon-IP Inc.,, 1700 Diagonal Road, Suite 450, Alexandria, VA, 22314, US

(73) Assignee: Oracle International Corporation, Redwood Shores, CA (US)

(21) Appl. No.: 12/136,081

(22) Filed: Jun. 10, 2008

(51) Int. Cl. G06Q 10/00

(52) U.S. Cl. 705/1

(57) ABSTRACT

A CRM client architecture conducive to interaction with other applications executing in a same client system. In an embodiment, an agent is displayed a toolbar in response to an incoming contact from a CRM server, and the user can select one of the options based on the buttons contained in the toolbar. When the user selects an appropriate button (e.g., accept option), the CRM client application is executed to facilitate the handling of the incoming contact by the agent. On a reject option being selected by the agent, a corresponding action (e.g., appropriate notification to a CRM server) may be performed.

### BACKGROUND

1. Technical Field

The present disclosure relates to customer relationship management (CRM) and more specifically to CRM client architecture conducive to interaction with other applications executing in the same client system.

2. Related Art

A Customer Relationship Management (CRM) system enables a business entity (such as a company) to manage relationship with its customers while providing various functions such as marketing campaigns, enquiries, sales, technical support, complaints handling, billing, etc. In a typical scenario, a business entity has many representatives to communicate with different customers of the business entity using the CRM system.

CRM systems are often implemented using client-server architecture. In general, a CRM client (software executing on a client system) enables a representative (acting on behalf of a business entity) to interact (e.g., by email, telephone, etc.) with a customer, while a CRM server provides various centralized activities such as maintaining information related to customers/communications, and managing (e.g., call assignment to individual representatives) the interaction between the customers and representatives.

It is often desirable that the CRM client architecture be conducive to interaction with other applications executing on the same client system. For example, client systems are increasingly being used from non-office locations such as homes, so that representatives can provide customer service/interaction function from the convenience of their homes. At least in such a scenario, a client system may be used to execute various other user applications (e.g., word processing software, web browser software, music player, etc.). It may accordingly be desirable that the CRM client architecture be conducive to interaction with other applications on the same client system.

### BRIEF DESCRIPTION OF THE DRAWINGS

Example embodiments of the present invention are described with reference to the accompanying drawings briefly described below.

FIG. 1 is a block diagram illustrating an example environment (computing system) in which several aspects of the present invention can be implemented.

FIG. 2 is a block diagram of a CRM system facilitating the handling of an incoming contact by a contact center agent in one embodiment.

FIG. 3 depicts a user interface for handling contacts with customers in one embodiment.

FIG. 4 is a block diagram of a CRM system facilitating the handling of contacts by a contact center agent while interacting with other applications in one embodiment.

FIG. 5 is a flowchart illustrating the manner in which incoming contacts are handled while making it convenient for a user to interact with other applications according to an aspect of the present invention.

FIG. 6 depicts a user interface containing a toolbar which enables contact center agents to handle contacts while interacting with other applications in one embodiment.

FIG. 7 is a block diagram illustrating the details of digital processing system 700 in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

### 1. Overview

An aspect of the present invention provides a CRM client architecture conducive to interaction with other applications executing in a same client system. In an embodiment, a toolbar is displayed in response to an incoming contact from a CRM server, and an agent/representative can select one of the options based on the buttons contained in the toolbar.

When the user selects an appropriate button (e.g., accept option), the CRM client application is executed to facilitate the handling of the incoming contact by the agent. On a reject option being selected by the agent, a corresponding action (e.g., appropriate notification to a CRM server) may be performed.

In an implementation of the user interface, the window corresponding to the CRM client application is required to be active (on top of other interface elements of other applications). Since the CRM client may be executed only when the agent accepts the incoming contact, the user has enhanced opportunity to interact with non-CRM applications, thereby making the CRM client architecture more conducive to interacting with other applications.

Several aspects of the invention are described below with reference to examples for illustration. It should be understood that numerous specific details, relationships, and methods are set forth to provide a full understanding of the invention. For example, many of the functions units described in this specification have been labeled as modules/blocks in order to more particularly emphasize their implementation independence.

A module/block may be implemented as a hardware circuit containing custom very large scale integration circuits or gate arrays, off-the-shelf semiconductors such as logic chips, transistors or other discrete components. A module/block may also be implemented in programmable hardware devices such as field programmable gate arrays, programmable array logic, programmable logic devices, or the like.

Modules/blocks may also be implemented in software for execution by various types of processors. An identified module of executable code may, for instance, contain one or more physical or logical blocks of computer instructions which may, for instance, be organized as an object, procedure, or function. Nevertheless, the executables of an identified module need not be physically located together, but may contain disparate instructions stored in different locations which when joined logically together constitute the module/block and achieve the stated purpose for the module/block.

It may be appreciated that a module/block of executable code could be a single instruction, or many instructions and may even be distributed over several code segments, among different programs, and across several memory devices. Further, the functionality described with reference to a single module/block can be split across multiple modules/blocks or alternatively the functionality described with respect to multiple modules/blocks can be combined into a single (or other combination of blocks) as will be apparent to a skilled practitioner based on the disclosure provided herein.

Similarly, operational data may be identified and illustrated herein within modules and may be embodied in any suitable form and organized within any suitable type of data structure. The operational data may be collected as a single data set, or may be distributed over different locations including over different member disks, and may exist, at least partially, merely as electronic signals on a system or network.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the following description, numerous specific details are provided such as examples of programming, software modules, user selections, network transactions, database queries, database structures, hardware modules, hardware circuits, hardware chips, etc., to provide a thorough understanding of embodiments of the invention.

However one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore the features/aspects described can be practiced in various combinations, though only some of the combinations are described herein for conciseness.

### 2. Example Environment

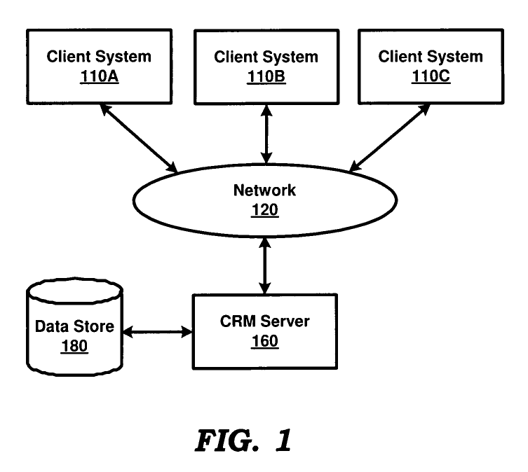

FIG. 1 is a block diagram illustrating an example environment (computing system) in which several aspects of the present invention can be implemented. The example computing system represents a CRM system used by a business entity to manage relationship/communications with its customers. The block diagram is shown containing client systems 110A-110C, network 120, CRM server 160, and data store 180.

Merely for illustration, only representative number/type of systems is shown in the Figure. Many environments often contain many more systems, both in number and type, depending on the purpose for which the environment is designed. Each block of FIG. 1 is described below in further detail.

Network 120 provides connectivity between client systems 110A-110C and CRM server 160. Network 120 may be implemented using protocols such as Internet Protocol (IP) well known in the relevant arts. In general, in IP environments, an IP packet is used as a basic unit of transport, with the source address being set to the IP address assigned to the source system from which the packet originates and the destination address set to the IP address of the target system to which the packet is to be eventually delivered.

Data store 180 represents a non-volatile storage facilitating storage and retrieval of a collection of data by applications (modules) executing in CRM server 160. Data store 180 may maintain data related to business transactions (for example, billing information, marketing deals), communications with customers, etc., in real time. Data store 180 may also store historical (transaction) data extracted from different external data sources (not shown).

In one embodiment, data store 180 is implemented using relational database technologies and therefore provides storage and retrieval of data using structured queries such as SQL (Structured Query Language). SQL refers to a special-purpose, generally non-procedural language that supports the definition, manipulation, and control of data in systems implementing relational database technologies.

CRM server 160 represents a server system, such as a web and/or application server, executing various application modules for handling different CRM functions such as marketing, billing, customer contact, etc. Each application module is designed to provide corresponding services to the end users using client systems 110A-110C.

For example, a contact application module may be designed to accept requests for performing specific tasks from end users handling calls from customers of the business entity (and who are commonly referred to as “contact center agents” or just “agents”), to perform the requested tasks and to send corresponding responses containing the results of performance of the requested tasks to the requesting client system.

The performance of the requested tasks by the application modules may cause addition, modification and/or deletion of the data (such as the customer marketing/billing/call information) stored in data store 180. CRM server 160 may also contain other software programs such as operating system, device drivers, etc., (not shown) that provides a (common) run time environment facilitating the execution of the business/enterprise applications.

Each of client systems 110A-110C represents a system such as a personal computer, workstation, mobile station, etc., used by end users (such as agents) to generate requests to application modules (or applications) executing in CRM server 160. The requests may be generated using appropriate user interfaces. In general, a client system requests an application (module) for performing desired tasks and receives corresponding responses containing the results of performance of the requested tasks from the application (module).

Client systems 110A-110C may be used by contact center agents/representatives to access specific information related to different customers, for example, while handling incoming product support or information inquiry contacts from the customers. The customer related information (stored in data store 180) may also be accessed to enable outgoing contacts for telemarketing, sending reminders, debt collection etc.

The incoming and outgoing contacts may be in the form of telephone calls, letters, faxes, e-mails, web updates, etc. or in general any form of communication as agreed between the customers and the business entity. The manner in which a CRM system facilitates a contact center agent to handle an incoming contact is described below with examples.

### 3. Handling an Incoming Contact

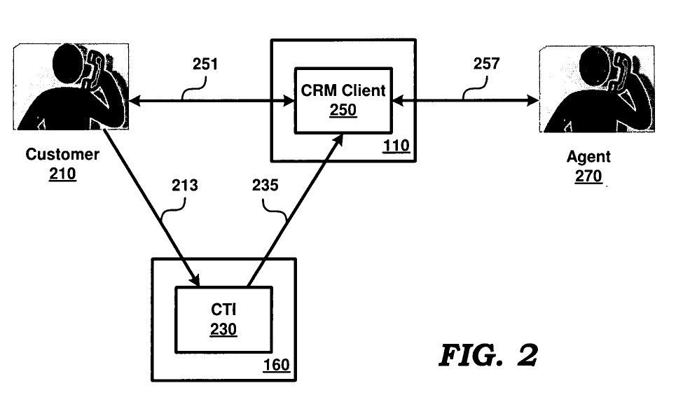

FIG. 2 is a block diagram of a CRM system facilitating the handling of an incoming contact by a contact center agent in one embodiment. The block diagram is shown containing customer 210, CTI (computer telephony integration) 230 executing in CRM server 160, CRM client 250 executing in client system 110A and agent 270. Each block of FIG. 1 is described below in further detail.

Customer 210 represents a single individual or a group of individuals who have a business relationship with a business entity/organization, or in other words, individuals who receive and/or use and/or are directly affected by the products and services of the business entity. Customer 210 may use/receive the products/services after making appropriate payments to the business entity/organization.

Customer 210 may wish to contact the business entity to receive support and/or make complaints about the products/services of the business entity. Accordingly, customer 210 may initiate contact with the CRM system, for example, by placing a call using a telephone to a pre-specified telephone number, sending a mail to pre-specified email id, etc.

The description is continued assuming that customer 210 initiates contact by placing a telephone call to the CRM system. However, it may be appreciated that the various features of the present invention may be implemented in the context of other types of contact such as emails, letters, faxes etc. as will be apparent to one skilled in the relevant arts by reading the description provided herewith.

CTI 230 represents an application module executing in CRM server 160, which receives the telephone call (initiated by customer 210) via path 213 and determines the identity of the customer in a pre-determined manner. For example, the identity of customer 210 may be determined based on the telephone number from which customer 210 is placing the telephone call. Alternatively, CTI 230 may require customer 210 to specify a unique identification number (provided previously) using the telephone (and receive it via path 213).

CTI 230 may also retrieve the information related to customer 210 from data store 180. The information may be retrieved based on the determined identity of customer 210. Alternatively, a different application module (not shown) may be provided for retrieving the customer related information from data store 180.

CTI 230 may also determine the specific agent/representative to which the incoming contact is to be assigned. The determination may be performed based on agent information (e.g., the time durations during which each agent is available to receive incoming contacts, the status of each agent, the number of contacts already handled by each agent etc.) maintained in data store 180. CTI 230 (and/or the different application module) then forwards the identity and related information of customer 210 to the client system used by the determined agent/representative (in particular to the CRM client application executing in the client system).

The description is continued assuming that CTI 230 determines that the incoming contact is to be assigned to agent 270 (using client system 110A and executing CRM client 250). Accordingly, CTI 230 sends the customer related information to CRM client 250 (via path 235). It may be appreciated that a same (or similar) CRM client may be executed in other client systems (such as 110B and 110C) to facilitate other agents to handle other (types of) incoming contacts received from different customers at the same/different time instances.

CRM client 250 represents an application executing in client system 110A, which enables contact center agents to process incoming contacts received from customers. On receiving (via path 235) the identification and other related information regarding customer 210, CRM client 250 displays the received information to agent 270. The customer related information may be displayed on a display unit (not shown) associated with client system 110A.

Though not shown, CRM client 250 may also send requests to other (for example, marketing and billing) application modules executing in CRM server 160 to retrieve and display other (marketing/billing) information related to customer 210. CRM client 250 may also store/retrieve data from data store 180 through an application module executing in CRM server 160.

Agent 270 represents an individual/representative who is trained to handle incoming contacts (e.g. calls) from various customers of the business entity. Agent 270 may be trained to know the various features/issues related to the different products/services offered by the business entity. As such, agent 270 may be capable of providing support to the customers and also to handle various complaints received corresponding to the different products/services.

Agent 270 may receive an indication from CRM client 250 indicating that customer 210 wishes to contact the business entity. The indication may be provided in the form of a visual indicator displayed on a display unit and/or an audible pre-configured alert sound. Agent 270 may also view the identity of customer 210 and the customer related information displayed by CRM client 250.

Agent 270 may then accept to handle the incoming contact (telephone call) by providing an appropriate accept indication to CRM client 250, for example, by selecting a specific button, by speaking a pre-specified word in a microphone etc.

In response to the accept indication, CRM client 250 may establish a connection between customer 210 (via path 251) and agent 270 (via path 257), thereby enabling agent 270 to speak (or otherwise communicate) to customer 210. Agent 270 may then determine the reason of call (for example, information required, support required, complaint to be made etc.) and the appropriate actions to be performed on behalf of customer 210.

CRM client 250 may still monitor the telephone call (for example, to determine the time duration of the call, the selections made by customer 210, etc.) during the interaction between customer 210 and agent 270. Further, CRM client 250 may enable agent 270 to perform the determined appropriate actions, to indicate the feedback received from customer 210 etc. In general, CRM client 250 facilitates agent 270 in managing the communication (and in turn the relationship) with customer 210 on behalf of the business entity.

Alternatively, agent 270 may decide to reject the incoming telephone call. Rejection may include terminating the telephone call, forwarding the call to another agent, or putting the call on hold/suspend (for later attention/processing). Accordingly, agent 270 may provide a corresponding reject indication (e.g., by selecting appropriate buttons, by speaking pre-defined words etc.) to CRM client 250.

In response to a reject indication, CRM client 250 may perform actions based on the manner of rejection. For example, on termination of the telephone call, the CRM client 250 may inform CRM server 160 of the termination action performed (and/or the reason for termination as indicated by agent 270). CRM client 250 may also play an appropriate message to customer 210 via path 251.

Other scenarios of handling the incoming call by agent 270 may include transferring the call to another agent working on another client system (for example, 110B). The call transfer operation may be a blind transfer or a consultative transfer. Blind transfer may involve just forwarding the call to another agent, while a consultative transfer may involve putting the incoming call on hold, and starting a parallel call with another agent/party (using client system 110B) for consultation, and based on the consultation forward the held-up incoming call to the consulted agent/party.

Many other call control operations are possible on the incoming call, such as conferencing a call, retrieving a suspended call, dropping the call, supervising a call being attended by another agent, etc. as will be apparent to one skilled in relevant arts.

Thus, CRM client 250 executing in client system 110A in association with the applications (such as CTI 230) executing in CRM server 160 (together constituting the CRM system) facilitates handling of an incoming contact/telephone call by a contact center agent.

Similarly, the CRM system may be designed to handle outgoing calls to customers. For example, CRM client 250 may be designed to enable agent 270 to request for placing an outgoing call to a specific customer. On receiving such a request, CRM client 250 may retrieve (and display) the information related to the specific customer from data store 180 (by sending requests to applications in CRM server 160) and then initiate contact with the specific customer.

It may be appreciated that the contact center agents (such as agent 270) may be provided an appropriate user interface (by CRM client 250) for handling the incoming/outgoing contacts with customers. The description is continued illustrating one such user interface provided by CRM client 250 in one embodiment.

### 4. User Interface for Handling Contacts

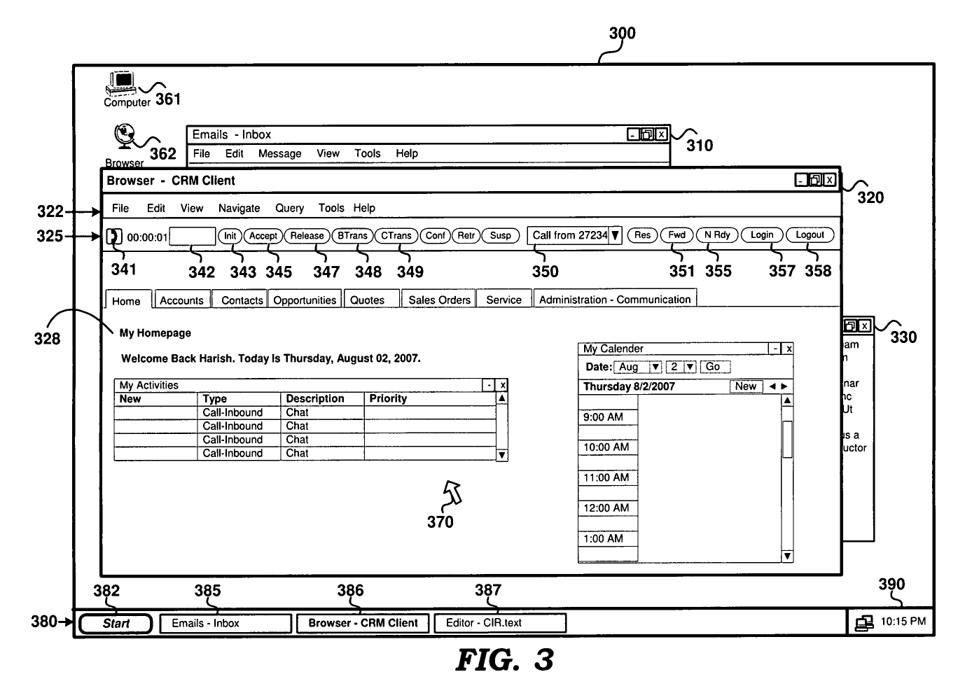

FIG. 3 depicts a user interface for handling contacts with customers in one embodiment. Desktop 300 represents a portion of a screen provided by an operating system executing in client system 110A. Desktop 300 may be displayed on a display unit (not shown) associated with client system 110A.

In general, an operating system enables multiple applications to be executed in a system while providing (shared) access to the various hardware components of the system in a known way. The operating system (e.g., Windows XP Operating System from Microsoft Corporation, Linux Operating System) also enables each of the applications to interact with a user by providing a corresponding user interface commonly termed as a window in the execution state of the applications.

Thus, windows 310, 320, and 330 represent user interfaces provided by corresponding user applications such as an email application, a browser application, and a text editor application. The browser application is shown displaying the web pages provided by a CRM client application (such as CRM client 250).

Accordingly, window 320 depicts a user interface provided by CRM client 250 for handling incoming/outgoing contacts with customers. Menu 322 enables a user to access/perform the various actions provided by CRM client 250. Toolbar 325 is an interface element containing graphical/textual representations of some of the commonly used actions provided by CRM client 250.

In general, a toolbar is an interface element, commonly provided in the form of a panel containing buttons, icons, menus or other input or output elements, which provides convenient access to commonly used actions (provided by an application). The specific input/output elements and/or the corresponding commonly used actions to be included in a toolbar (such as toolbar 325) may be pre-configured (by a developer of the application) or may be specified by the user (when desired).

Toolbar 325 is shown containing various interface elements such as icon 341, text field 342, select field 350, and buttons 343, 345, 347-349, 351, 355, 357, and 358. Icon 341 provides a visual indication of the type of incoming contact (with the phone icon indicating an incoming telephone call) while select field 350 indicates the identity of the incoming contact (as shown by the text “Call from 27234”).

Button 345 (labeled “Accept”) enables the user/agent to accept the incoming contact/call (that is, provide an accept indication to CRM client 250). Buttons 347, 348, 349, and 351 (respectively labeled “Release”, “BTrans”, “CTrans”, and “Fwd”) enables the user to respectively release/terminate, blind transfer, consultative transfer or forward the incoming contact/call (thereby providing a reject indication to CRM client 250).

A user/agent may select button 355 (labeled “N Rdy”) to indicate that the agent is not ready to accept any incoming contacts. The user may also use buttons 357 and 358 (respectively labeled “Login” and “Logout”) to respectively logon to CRM client 250 (by providing authentication information required by the CTI 230 for accessing telephony related functionality) or to logout of the CRM client 250 (thereby indicating that no further actions are being performed by the user with respect to CTI functionality). The agent may also use text field 342 in combination with button 343 (labeled “Init”) to request for an outgoing contact/call.

Display area 328 depicts information related to the agent who has logged in to the CRM client. The agent related information may include the actions to be performed, the details of the actions previously performed by the agent etc. The agent related information may be retrieved from data store 180 (or maintained locally by CRM client 250). Display area 328 may also display the customer related information in a scenario that the user/agent accepts the incoming contact.

Similarly, other windows such as 310 and 330 may have other interface elements which enable a user to interact with the corresponding applications. A user may interact with the interface elements (for example, select the icons, specify text etc.) and/or windows using an appropriate input device such as keyboard, mouse etc. Pointer 370 is a graphical representation of a pointing device such as a mouse, and provides a visual feedback to the user regarding the actions performed with the pointing device. For example, pointer 370 may be shown moving over/in desktop 300 according to the movement of the pointing device.

It may be appreciated that the applications (and the corresponding windows) may be initiated and monitored using various interface elements provided by the operating system in desktop 300 as described briefly below.

Icons 361-362 are graphical representations of the applications provided in desktop 300. The execution of the corresponding applications may be initiated by a user by selecting the appropriate one of icons 361-362. For example, a user may select (by double clicking) icon 362 to cause an instance of a browser application to be executed.

Taskbar 380 is an interface element provided by the operating system to enable users to initialize and monitor applications (and the corresponding windows). Taskbar 380 is shown containing start button 382, application buttons 385-387 and system tray 390.

Start button 382 enables user to access and initialize the desired applications, to access new or recently accessed documents and/or to access the settings governing the operation of the system etc. System tray 390 (also termed as notification area) displays graphical icons and/or text which convey status information related to executing applications. For example, the network icon shown in 390 may be animated to indicate the status of communication on the network to which the system is connected.

Each of application buttons 385-387 represents a corresponding window provided by an application. In the present embodiment, application buttons 385-387 respectively represent windows 310, 320 and 330. The application buttons enables a user to select the desired application for interaction. On selection of an application button, the corresponding window (termed the active window) is displayed on top of all other windows thereby enabling the user to interact with the corresponding application.

Thus, it may be observed that application button 386 is shown to be selected (the label “Browser—CRM Client” being shown in bold) in taskbar 380, and the corresponding window 320 is shown to be on top of all other windows. A user may select any desired application button to make the corresponding window the active window. The user may alternatively select the desired window directly to make it the active window.

In one prior approach, a CRM client application enables users/agents to handle incoming/outgoing contacts only when the corresponding window is active. Such a requirement may necessitate that window 320 be maintained on top of all other windows at all time instances for the agent/user to receive incoming contacts.

It may be appreciated that by making a window to be the active window, the interaction of the user with other non-active windows (and other interface elements of desktop 300) is removed or considerably curtailed. For example, in FIG. 3, by making window 320 as the active window, the user may be unable to edit the text using the editor application in window 330 and also unable to view the newly received mails displayed by the email application in window 310. Further, the user/agent may not be able to access icons displayed below window 320. Thus, in the prior approach, the interaction of the user/agent with other applications is removed or considerably curtailed.

It may be desirable that a CRM client application provide various actions to a user/agent while enabling the user/agent to interact with other applications (such as the email and editor applications) executing in the same client system. In particular, it may be desirable that at least some of actions described with respect to toolbar 325 be made available to the user/agent while interacting with other applications.

Various aspects of the present invention provides for a CRM client architecture which enables interaction with other applications executing in the same client system while providing the user/agent the ability to handle incoming/outgoing contacts in real-time as described below with examples.

### 5. Handling Contacts While Interacting with Other Applications

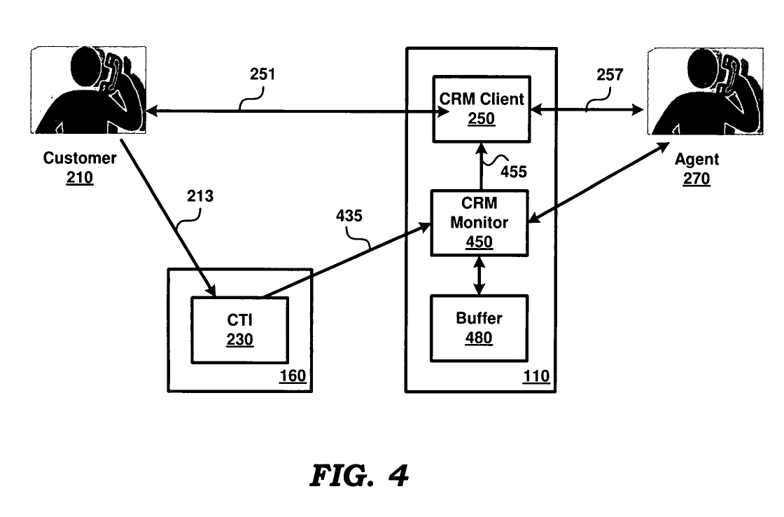

FIG. 4 is a block diagram of a CRM system facilitating the handling of contacts by a contact center agent while interacting with other applications in one embodiment. The block diagram is shown containing customer 210, CTI (computer telephony integration) 230, CRM client 250, CRM monitor 450 executing in client system 110A (along with CRM client 250), buffer 480, and agent 270. Each of the blocks of FIG. 4 is described below in further detail.

Similar numbers are used to represent corresponding blocks/paths of FIGS. 2 and 4 and hence the description of such blocks/paths is not repeated for conciseness. Thus, FIG. 4 depicts customer 210 as initiating a contact with the CRM system (via path 213) and CTI 230 as forwarding the identity and related information of customer 210 to client system 110A (via path 435).

Buffer 480 represents a temporary storage in a volatile memory in client system 110A. Buffer 480 may be used by CRM monitor 450 to maintain agent-related information (such as whether agent 270 is ready for incoming contacts, is logged in, or logged out of the CRM system, etc.).

CRM monitor 450, provided according to an aspect of the present invention, represents an application executing in client system 110A (along with CRM client 250) which enables contact center agents to process incoming contacts received from customers while interacting with other applications executing in client system 110A as described below with examples.

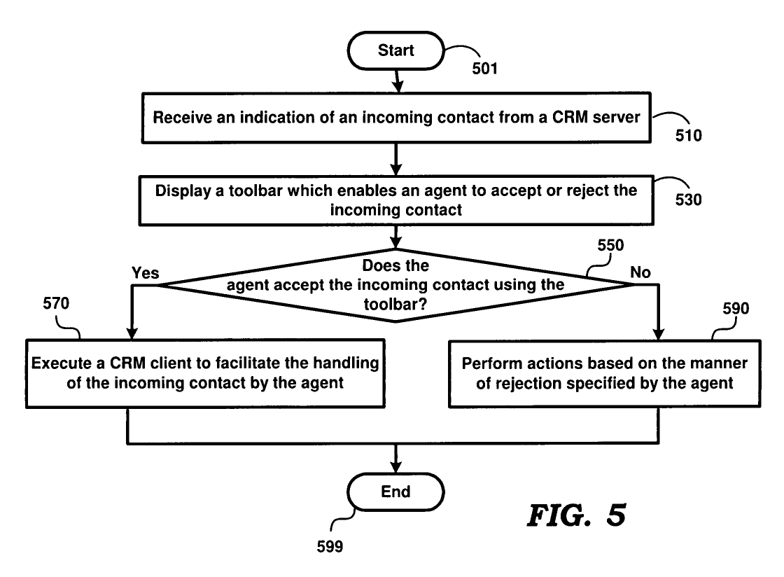

FIG. 5 is a flowchart illustrating the manner in which incoming contacts are handled while making it convenient for a user to interact with other applications according to an aspect of the present invention. The flowchart is described with respect to FIGS. 1, 2, and 4 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 501, in which control immediately passes to step 510.

In step 510, CRM monitor 450 receives an indication of an incoming contact from a CRM server. The indication may be received via path 435 from CTI 230 executing in CRM server 160. The indication may indicate that an incoming contact is received from customer 210. As described above, the identification and the customer-related information of customer 210 (initiating the incoming contact) may also be received along with the indication.

In step 530, CRM monitor 450 displays a toolbar which enables agent 270 to accept or reject the incoming contact. The toolbar may be displayed in response to receiving the indication from the CRM server. The toolbar may be displayed on a display (not shown) associated with client system 110A along with other applications executing in client system 110A such that the user interaction with the other applications is not curtailed as described below with examples.

As described above, the displayed toolbar may contain various links/buttons which enable agent 270 to accept or reject the incoming contact, for example, some of the buttons described above with respect to toolbar 325.

In step 550, CRM monitor 450 determines whether agent 270 accepts the incoming contact using the toolbar (provided on the display). The determination may be performed based on the link/button selected by agent 270.

As described above, the selection of some of the links/buttons in the displayed toolbar may provide an accept indication to CRM monitor 450 (via path 457), while the selection of other links/buttons may provide a reject indication to CRM monitor 450 (via path 457). Control passes to step 470 if an accept indication is provided and to step 490 otherwise.

In step 570, CRM monitor 450 executes CRM client 250 to facilitate the handling of the incoming contact by the agent. The execution (as represented by path 450) of CRM client 250 may be performed in a known way. Once execution of CRM client 250 is commenced, CRM client 250 facilitates the handling of the incoming contact (via paths 251 and 257) similar to the manner described above and hence the description is not repeated here for conciseness.

CRM client 250 may also access call control functionality provided by CTI 230 such as making an outbound call, waiting for inbound calls, accepting calls, transferring calls, etc (via path 235 shown in FIG. 2). Control then passes to step 599, where the flowchart ends.

In step 590, CRM monitor 450 performs actions based on the manner of rejection specified by agent 270. The manner of rejection may be indicated by the specific link/button selected by agent 270 in the displayed toolbar. The actions corresponding to the manner of rejection may be performed similar to the manner in which CRM client 250 performs the actions as described above with respect to FIG. 2 and hence the description is not repeated here for conciseness.

Alternatively, CRM monitor 450 may be designed to execute CRM client 250 with the manner of rejection passed as a parameter to CRM client 250. CRM client 250 then may perform the action corresponding to the parameter (manner of rejection). Control then passes to step 599, where the flowchart ends.

Thus, a toolbar provided along with other applications executing in the client system enables a contact center agent to handle incoming/outgoing contacts while interacting with the other applications. In one embodiment, the window corresponding to CRM client 250 is required to be active (displayed on top, among other interface elements) as in the prior approach described above.

Accordingly, due to the operation of steps 530, 550 and 570, CRM client 250 is in an execution state only when required (and in a non-execution state otherwise). Accordingly, the window corresponding to CRM client 250 is not active (when not required), thereby providing an enhanced opportunity to agent 270 to interact with the windows of other applications. Thus, the CRM client architecture is made conducive for interaction with other applications executing in the same client system. The description is continued illustrating the manner in which the above-described toolbar is provided in one embodiment.

### 6. Displaying a Toolbar Along with Other Applications

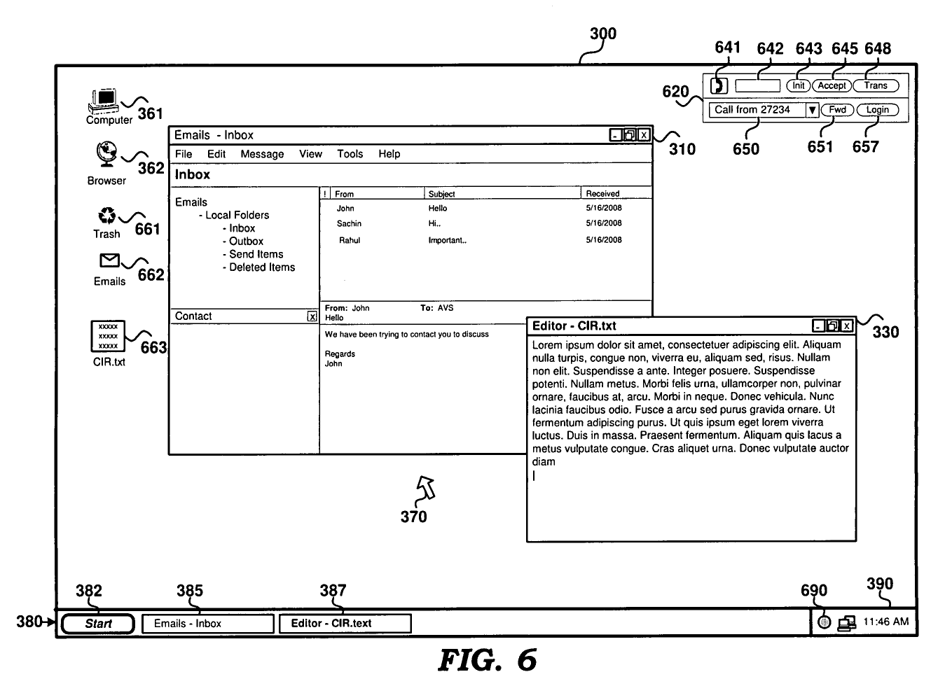

FIG. 6 depicts a user interface containing a toolbar which enables contact center agents to handle contacts while interacting with other applications in one embodiment. Similar numbers are used to represent corresponding portions of FIGS. 3 and 6 and hence the description of such portions is not repeated for conciseness.

Desktop 300 is shown containing windows 310 and 330 (interfaces respectively provided by an email and an editor application), and a taskbar 380 containing the application buttons 385 and 387 (corresponding respectively to windows 310 and 330). It may be observed that window 320 corresponding to the interface provided by a browser application (and displaying the web pages provided by CRM client 250) is not displayed in desktop 300.

Toolbar 620 displayed at the top right corner of desktop 300 represents an interface element provided by CRM monitor 450 in response to receiving an indication of an incoming contact from CRM server 160 (for example, from CTI 230). Toolbar 620 is shown containing various interface elements such as icon 641, text field 642, select field 650, and buttons 643, 645, 648, 651, and 657.

The interface elements of toolbar 620 are similar to the corresponding interface elements described above with respect to toolbar 325 and hence the description of the interface elements is not repeated here for conciseness. Thus, icon 641 and select field 650 indicate the type and the identity of the incoming contact, button 645 enables the user/agent to accept the incoming contact/call (that is, provide an accept indication to CRM monitor 450) and buttons 648 and 651 enables the user to respectively transfer or forward the incoming contact/call (thereby providing a reject indication to CRM monitor 450).

Further, button 657 may be used by a user/agent to logon to CRM client 250 (and/or implicitly to CTI 230) by providing appropriate authentication information. The user/agent may also use text field 642 (to provide a desired customer to be selected) in combination with button 643 to request for an outgoing contact/call. In response, CRM monitor 450 may execute CRM client 250, potentially passing the provided customer information as a parameter. CRM client 250 may then establish an outgoing contact between agent 270 and customer 210 using the applications executing in CRM server 160 (e.g., CTI 230).

Icon 690 displayed in system tray 390 by CRM monitor 450 indicates the status information related to incoming/outgoing contacts. For example, icon 690 may be displayed as a flashing green filled circle to indicate an incoming contact. Alternatively, icon 690 may be animated in a pre-determined manner. The animation of icon 690 and the display of toolbar 630 may be performed at the same or different time instances.

It may be observed that window 330 is shown to be the active window, thereby enabling the user (e.g. agent 270) to edit the test using the editor application. Similarly, the enhanced view of window 310 enables the user/agent to view the newly received mails displayed by the email application. Further, icons 661-663 are shown visible on desktop 300, thereby enabling the user/agent to initiate execution of the applications corresponding to the icons.

Thus, it may be appreciated that the non-display of window 320 (corresponding to the CRM client 250) enables the user/agent to interact with other applications executing in client system 110A. Meanwhile, toolbar 620 (along with icon 690) enables the user/agent to handle incoming/outgoing contacts received from CRM server 160.

Though not shown, it may be appreciated that window 320 may be displayed on execution of CRM client 250 (step 570) in response to the user/agent accepting an incoming contact/call. Window 320 may also be displayed in a scenario that the user/agent rejects an incoming contact/call and CRM monitor 450 is designed to execute CRM client 250 with the manner of rejection as a parameter.

Thus, the CRM client architecture of FIG. 4 enables (users/agents) interaction with other applications executing in the same client system while handling incoming/outgoing contacts.

It should be appreciated that the features described above can be implemented in various embodiments as a desired combination of one or more of hardware, software, and firmware. The description is continued with respect to an embodiment in which various features are operative when software instructions are executed.

### 7. Digital Processing System

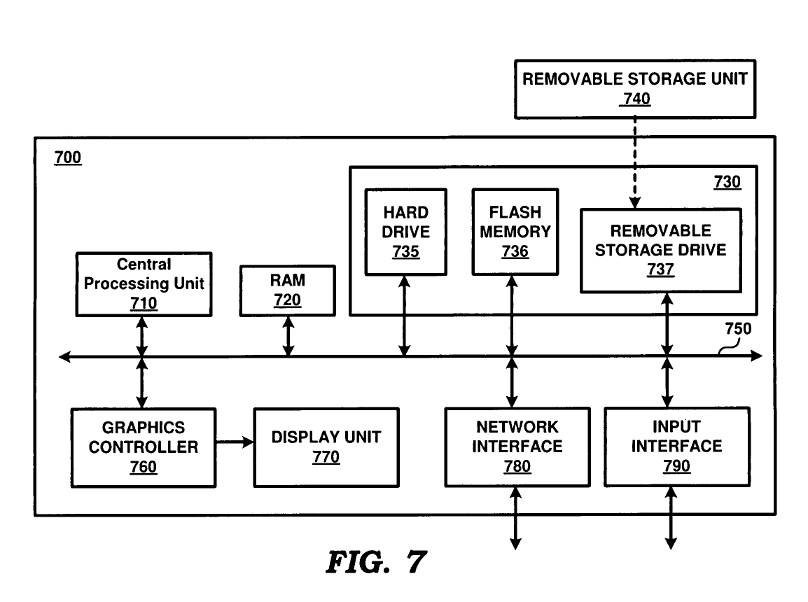

FIG. 7 is a block diagram illustrating the details of digital processing system 700 in which various aspects of the present invention are operative by execution of appropriate software instructions. Digital processing system 700 may correspond to any system executing CRM monitor 450 (e.g. client system 110A).

Digital processing system 700 may contain one or more processors (such as a central processing unit (CPU) 710), random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present invention. CPU 710 may contain multiple processing units, with each processing unit potentially being designed for a specific task. Alternatively, CPU 710 may contain only a single general-purpose processing unit. RAM 720 may receive instructions from secondary memory 730 using communication path 750.

Graphics controller 760 generates display signals (e.g., in RGB format) to display unit 770 based on data/instructions received from CPU 710. Display unit 770 contains a display screen to display the images (such as the portions of the user interfaces depicted in FIGS. 3 and 6) defined by the display signals. Input interface 790 may correspond to a keyboard and a pointing device (e.g., touch-pad, mouse) and may be used to provide various inputs (for example, for interacting with the interfaces of FIGS. 3 and 6).

Network interface 780 provides connectivity to a network (e.g., using Internet Protocol), and may be used to communicate with other connected systems (such as CRM server 160) of FIG. 1.

Secondary memory 730 may contain hard drive 735, flash memory 736, and removable storage drive 737. Secondary memory 730 may store the data and software instructions, which enable digital processing system 700 to provide several features in accordance with the present invention.

In particular, the instructions corresponding to the CRM client may be stored in the secondary memory, and loaded into RAM 720 only upon execution. In general, when the instructions corresponding to an application are loaded into RAM 720 (in a state ready for processing by CPU 710) in a state suitable for execution, the application is said to be in an execution state and in a non-execution state otherwise.

In general, the instructions corresponding to the application are available in secondary storage, when the application is in both execution state or non-execution state, and loaded into RAM 720 for execution. As noted above, the CRM client may be executed (placed in an execution state) only after the user provides an indication (e.g., accept) to CRM monitor.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present invention described above.

### 8. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of enabling an agent to accept incoming contacts received from a customer relationship management (CRM) server while using other applications executing in a client system, said method being performed in said client system, said method comprising:
receiving an indication of an incoming contact from said CRM server;
displaying a set of buttons in the form of a toolbar on a display in response to said receiving of said indication, wherein said set of buttons includes a first button to accept said incoming contact; and
executing a CRM client application if said agent selects said first button, wherein said CRM client application facilitates the handling of said incoming contact by said agent.

2. The method of claim 1, further comprising:
executing a plurality of user applications in said client system, wherein each of said plurality of user applications provides a corresponding window on said display for interacting with said agent,
wherein a first window corresponding to said CRM client application is required to be the active window upon execution,
wherein having said CRM client application in a non-execution state prior to said executing provides an enhanced opportunity for windows other than said first window to be the active window, thereby making the CRM client architecture conducive to interaction with said plurality of user applications.

3. The method of claim 2, wherein a subset of said set of buttons indicates a corresponding manner of rejection of said incoming contact, said method further comprising:
performing a corresponding action associated with the manner of rejection if said agent selects the button indicating the manner of rejection.

4. The method of claim 3, wherein said subset of said set of buttons includes a second button to reject said incoming contact, a third button to forward said incoming contact, a fourth button to transfer said incoming contact, and a fifth button to suspend said incoming contact.

5. The method of claim 2, wherein a sixth button contained in said set of buttons enables said agent to initiate an outgoing contact with a customer while using other applications executing in said client system,
wherein said executing executes said CRM client application if said agent selects said sixth button, wherein said CRM client application facilitates the establishment of said outgoing contact with said customer using said CRM server.

6. The method of claim 5, wherein said incoming contact and said outgoing contact is one of a telephone call, a email message, a wireless message, a short message service (SMS), a chat message, a voice mail, and a fax communication.

7. A machine readable medium carrying one or more sequences of instructions causing a client system to enable an agent to accept incoming contacts received from a customer relationship management (CRM) server while using other applications executing in said client system, wherein execution of said one or more sequences of instructions by one or more processors contained in said client system causes said client system to perform the actions of:
receiving an indication of an incoming contact from said CRM server;
displaying a set of buttons in the form of a toolbar on a display in response to said receiving of said indication, wherein said set of buttons includes a first button to accept said incoming contact; and
executing a CRM client application if said agent selects said first button, wherein said CRM client application facilitates the handling of said incoming contact by said agent.

8. The machine readable medium of claim 7, further comprising one or more instructions for:
executing a plurality of user applications in said client system, wherein each of said plurality of user applications provides a corresponding window on said display for interacting with said agent,
wherein a first window corresponding to said CRM client application is required to be the active window upon execution,
wherein having said CRM client application in a non-execution state prior to said executing provides an enhanced opportunity for windows other than said first window to be the active window, thereby making the CRM client architecture conducive to interaction with said plurality of user applications.

9. The machine readable medium of claim 8, wherein a subset of said set of buttons indicates a corresponding manner of rejection of said incoming contact, further comprising one or more instructions for:
performing a corresponding action associated with the manner of rejection if said agent selects the button indicating the manner of rejection.

10. The machine readable medium of claim 9, wherein said subset of said set of buttons includes a second button to reject said incoming contact, a third button to forward said incoming contact, a fourth button to transfer said incoming contact, and a fifth button to suspend said incoming contact.

11. The machine readable medium of claim 8, wherein a sixth button contained in said set of buttons enables said agent to initiate an outgoing contact with a customer while using other applications executing in said client system,
wherein said executing executes said CRM client application if said agent selects said sixth button, wherein said CRM client application facilitates the establishment of said outgoing contact with said customer using said CRM server.

12. The machine readable medium of claim 11, wherein said incoming contact and said outgoing contact is one of a telephone call, a email message, a wireless message, a short message service (SMS), a chat message, a voice mail, and a fax communication.

13. A customer relationship management (CRM) system comprising:
a CRM server to send an indication of an incoming contact;
a client system to execute a CRM monitor application which enables an agent to accept said incoming contact while using other applications executing in said client system, said CRM monitor application being operable to:
receive said indication of said incoming contact from said CRM server;
display a set of buttons in the form of a toolbar on a display in response to said indication, wherein said set of buttons includes a first button to accept said incoming contact; and
execute a CRM client application if said agent selects said first button, wherein said CRM client application facilitates the handling of said incoming contact by said agent.

14. The CRM system of claim 13, wherein a plurality of user applications are executed in said client system, wherein each of said plurality of user applications provides a corresponding window on said display for interacting with said agent,
wherein a first window corresponding to said CRM client application is required to be the active window upon execution,
wherein having said CRM client application in a non-execution state prior to said executing provides an enhanced opportunity for windows other than said first window to be the active window, thereby making the CRM client architecture conducive to interaction with said plurality of user applications.

15. The CRM system of claim 14, wherein a subset of said set of buttons indicates a corresponding manner of rejection of said incoming contact, wherein said CRM monitor application performs a corresponding action associated with the manner of rejection if said agent selects the button indicating the manner of rejection.

16. The CRM system of claim 15, wherein said subset of said set of buttons includes a second button to reject said incoming contact, a third button to forward said incoming contact, a fourth button to transfer said incoming contact, and a fifth button to suspend said incoming contact.

17. The CRM system of claim 14, wherein a sixth button contained in said set of buttons enables said agent to initiate an outgoing contact with a customer while using other applications executing in said client system,
wherein said CRM monitor application executes said CRM client application if said agent selects said sixth button, wherein said CRM client application facilitates the establishment of said outgoing contact with said customer using said CRM server.

18. The CRM system of claim 17, wherein said incoming contact and said outgoing contact is one of a telephone call, a email message, a wireless message, a short message service (SMS), a chat message, a voice mail, and a fax communication.
